(19) United States
(12) Patent Application Publication
(10) Pub. No.: US 2025/0010240 A1
(43) Pub. Date: Jan. 9, 2025

(54) SYSTEM FOR CAPTURING AND REDIRECTING CARBON EMISSIONS TO A GREENHOUSE

(71) Applicant: Julia Naomi Seay, Fairburn, GA (US)

(72) Inventor: Julia Naomi Seay, Fairburn, GA (US)

(21) Appl. No.: 18/713,642

(22) PCT Filed: Dec. 2, 2022
(86) PCT No.: PCT/US2022/051721

§ 371 Date: May 25, 2024

Related U.S. Application Data
(60) Provisional application No. 63/264,806, filed on Dec. 2, 2021.

(51) Int. Cl. B01D 53/62; A01G 9/18; B01D 39/20; F16K 1/22; F17C 1/00

(52) U.S. Cl. CPC B01D 53/62; A01G 9/18; B01D 39/2062; B01D 39/2068; F16K 1/222; F17C 1/005

(57) ABSTRACT

A system for capturing and redirecting carbon emissions to a greenhouse is a system that reduces the levels of air pollution by capturing CO2 to grow plantation. The system includes a filtering mechanism, a pressure vessel, and a greenhouse. The filtering mechanism captures pollutants from an emissions stream to release clean air. The pressure vessel holds CO2 from the captured pollutants to be released into the greenhouse. The greenhouse enables the CO2 to be absorbed by the housed plantation for photosynthesis. The filtering mechanism includes a polluted stream inlet, a direct air capture (DAC) mechanism, a clean stream outlet, and a carbon dioxide (CO2) outlet. The polluted stream inlet enables the inflow of the emissions stream. The DAC mechanism enables the inflow of surrounding air. The clean stream outlet enables the outflow of clean air. The CO2 outlet enables the outflow of the captured CO2 towards the pressure vessel.

### FIELD OF THE INVENTION

The present invention relates generally to anti-pollution systems and air filtration systems. More specifically, the present invention provides a system that captures carbon emissions from a pollution source and redirects the captured carbon dioxide to a greenhouse to reduce carbon emissions to the atmosphere.

### BACKGROUND OF THE INVENTION

Global warming caused by an increase in carbon dioxide (CO2) emissions in the atmosphere is a rising concern for the planet. Since the industrial revolution circa 1870, CO2 levels in the atmosphere have almost doubled. CO2 causes a greenhouse effect on the planet which leads to a rising global temperature and corresponding rising sea level. If left unchecked, the accumulation of CO2 in the atmosphere could have potentially devastating consequences. However, nations across the globe continually increase their industrial output, thereby increasing their carbon footprint. Further, manufacturing facilities and factories continue to emit increased amounts of CO2 into the atmosphere despite calls to halt such activity. Therefore, there is a need for a system for reducing carbon dioxide emissions from large emitters such as manufacturing facilities and factories.

An objective of the present invention is to provide a system for capturing and redirecting carbon emissions to a greenhouse that reduces the overall CO2 emissions into the atmosphere. The system of the present invention provides a practical and efficient manner of reducing carbon emissions from sources such as manufacturing facilities by utilizing the carbon emissions to grow produce and other plant life. Another objective of the present invention is to provide a system for capturing and redirecting carbon emissions to a greenhouse that also reduces CO2 levels from the surroundings. The system of the present invention also captures air pollution from the surroundings to remove CO2 and other pollutants from the emissions stream to output clean air to the atmosphere. Additional features and benefits of the present invention are further discussed in the sections below.

### SUMMARY OF THE INVENTION

The present invention is a system for capturing and redirecting carbon emissions to a greenhouse. The present invention prevents carbon emissions from escaping into the atmosphere by redirecting the emissions to a greenhouse with plants that will absorb the carbon dioxide (CO2) and release oxygen. To do so, the system of the present invention includes a filtering mechanism and a greenhouse. The filtering mechanism can be retrofitted to any source of carbon emissions, such as a factory. The filtering mechanism then filters the pollutants from the emissions stream to output clean air. The filtering mechanism can include several filters including, but not limited to, a CO2 scrubber or activated charcoal/charcoal filter, to adequately capture and separate CO2 from the emissions stream. Additional pollutants and toxins can also be separated from the emissions stream to output clean air. Once the CO2 has been filtered out of the emissions stream, the system of the present invention redirects the CO2 to the greenhouse. The connection between the filtering mechanism and the greenhouse may vary depending on the filtering mechanism and the source of carbon emissions. Once the CO2 is redirected to the greenhouse, the CO2 is absorbed by plants housed within the greenhouse as part of photosynthesis. These plants may produce oxygen to be released into the atmosphere, which reduces the overall CO2 levels in the atmosphere.

In some embodiments of the present invention, the filtering mechanism can be retrofitted directly on top of an existing emissions vent, and the greenhouse may be placed directly on top of the filtering mechanism. The CO2 may then be pushed upwards through soil into the greenhouse or delivered by vents. In other embodiments of the present invention, the greenhouse can be hermetically sealed to prevent CO2 from escaping into the atmosphere. Furthermore, a plant catalog may be included for recommendations of what plants should be grown in the greenhouse including, but not limited to, difficulties in maintaining the plants and climate recommendations such as sunlight and watering requirements for the plants. The plants produced may be used as a food source for the surrounding region or for experimentation. Similarly, the pollutants removed from the system may be used for experimentation.

### BRIEF DESCRIPTION OF THE DRAWINGS

FIG. 1 is a schematic view of the overall system of the present invention.

FIG. 2 is a schematic view of the filtering mechanism of the present invention.

FIG. 3 is a top schematic view of the greenhouse of the present invention.

FIG. 4 is a side schematic view of the greenhouse of the present invention, wherein the electrical connections of the present invention are shown in solid lines, and wherein the electronic connections of the present invention are shown in dashed lines.

### DETAIL DESCRIPTIONS OF THE INVENTION

All illustrations of the drawings are for the purpose of describing selected versions of the present invention and are not intended to limit the scope of the present invention.

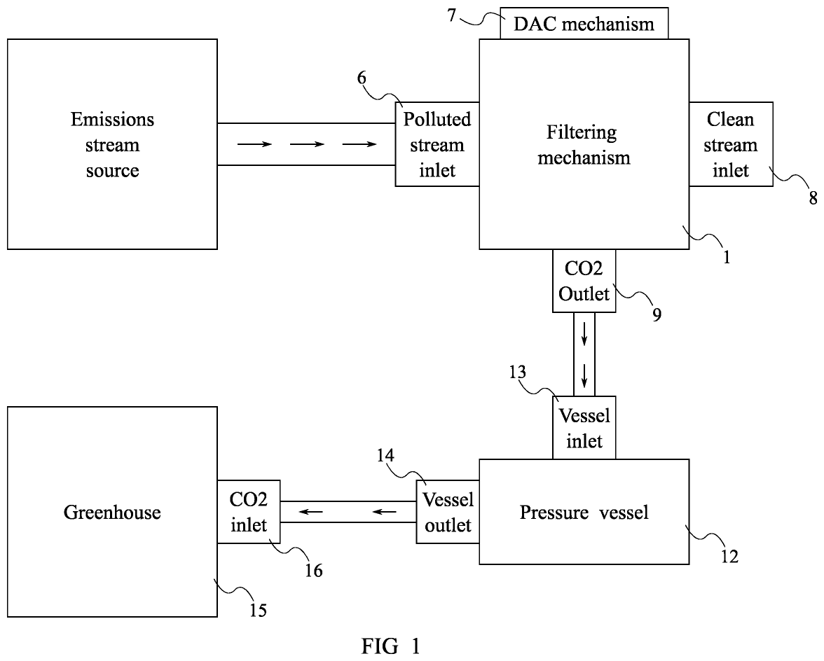

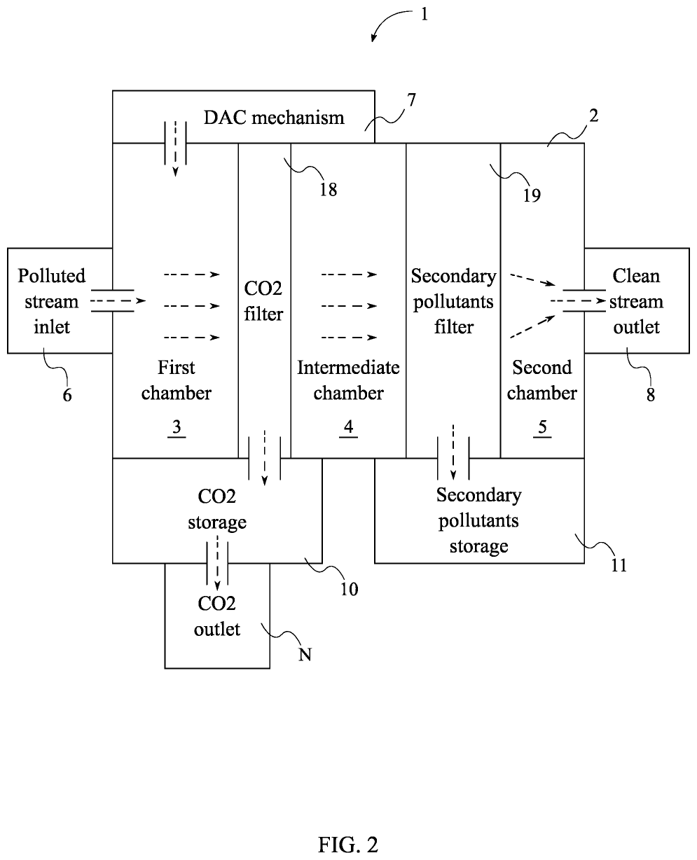

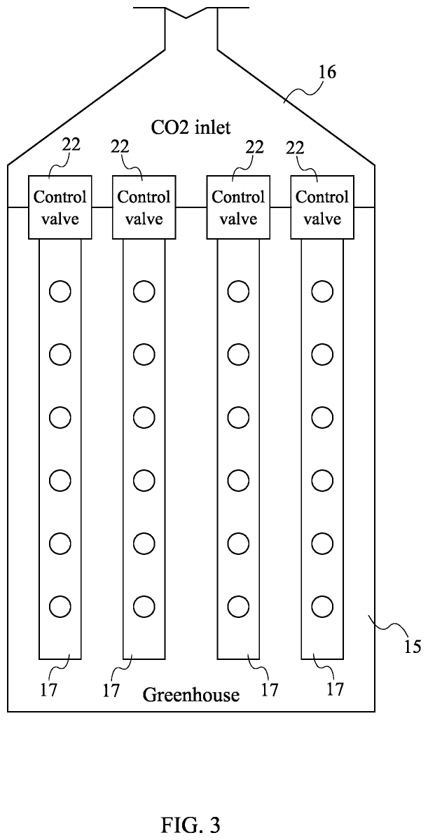

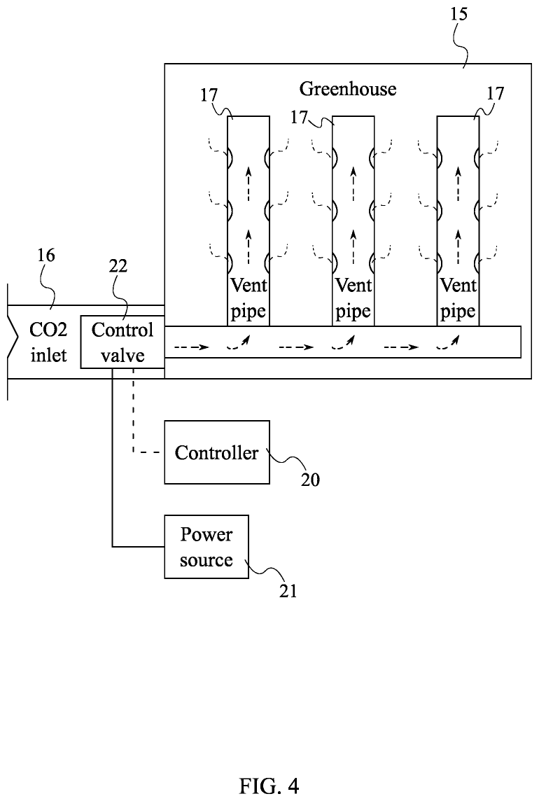

The present invention is a system for capturing and redirecting carbon emissions to a greenhouse that is used to reduce the levels of pollution in the atmosphere by utilizing the captured pollutants to grow plantation and for other purposes. As can be seen in FIG. 1 through 4, the present invention comprises a filtering mechanism 1, at least one pressure vessel 12, and a greenhouse 15. The filtering mechanism 1 serves to remove the pollutants from an emissions stream generated from a pollution source such as a manufacturing facility. The filtering mechanism 1 also redirects the captured CO2 from the captured pollutants to the greenhouse 15 and releases clean air into the atmosphere. The at least one pressure vessel 12 serves to temporarily hold the captured CO2 until the captured CO2 is released into the greenhouse 15. The greenhouse 15 houses the plantation in a controlled environment where the captured CO2 are absorbed by the plantation for photosynthesis.

The general configuration of the aforementioned components enables the reduction of pollution levels in the atmosphere. The filtering mechanism 1 is a structure that can be retrofitted to meet the sources of pollution emissions. For example, the filtering mechanism 1 can be retrofitted to the existing output structure of the source of pollution, such as the ventilation system of a factory. The filtering mechanism 1 prevents the release of pollutants by receiving the emissions stream and filtering the emissions stream. As can be seen in FIG. 1 through 4, the filtering mechanism 1 comprises a filtration housing 2, at least one polluted stream inlet 6, a direct air capture (DAC) mechanism 7, at least one clean stream outlet 8, and at least one carbon dioxide (CO2) outlet 9. The filtration housing 2 is a retrofittable structure that houses the components necessary to filter the emissions stream. The at least one polluted stream inlet 6 preferably corresponds to one or more openings through which the emissions stream enters the filtration housing 2. The DAC mechanism 7 serves to capture air from the surroundings to filter out any pollutants from the surrounding air. The at least one clean stream outlet 8 enables the outflow of the filtered stream into the atmosphere. The at least one CO2 outlet 9 enables the outflow of the captured CO2 from the emissions stream towards the at least one pressure vessel 12. Further, the at least one pressure vessel 12 comprises at least one vessel inlet 13 and at least one vessel outlet 14. The at least one vessel inlet 13 enables the flow of the captured CO2 from the filtering mechanism 1 into the at least one pressure vessel 12. The at least one vessel outlet 14 enables the flow of the stored CO2 in the at least one pressure vessel 12 to the greenhouse 15. Further, the greenhouse 15 comprises at least one CO2 inlet 16 which enables the inflow of the CO2 from the at least one pressure vessel 12 into the greenhouse 15.

In the preferred embodiment, as can be seen in FIG. 1 through 4, the at least one air pollutant inlet, the DAC mechanism 7, the at least one clean stream outlet 8, and the at least one CO2 outlet 9 are externally integrated into the filtration housing 2. The shape and size of the filtration housing 2 can be modified to match the requirements of the emissions source. Further, the at least one vessel inlet 13 and the at least one vessel outlet 14 are externally integrated into the at least one pressure vessel 12 to enable the connection of necessary tubing and other parts that enable the flow into and out of the at least one pressure vessel 12. Further, the at least one CO2 inlet 16 is externally integrated into the greenhouse 15 to enable the inflow of CO2 into the greenhouse 15. To enable the flow of captured CO2 from the filtration housing 2 to the at least one pressure vessel 12, the at least one CO2 outlet 9 is in fluid communication with the at least one vessel inlet 13. Similarly, the at least one vessel outlet 14 is in fluid communication with the at least one CO2 inlet 16 to enable the flow of the stored CO2 in the at least one pressure vessel 12 to the greenhouse 15. In other embodiments, the at least one pressure vessel 12 can be replaced with other mechanisms that enable the control flow of the captured CO2 from the filtering mechanism 1 to the greenhouse 15.

As can be seen in FIG. 1 through 4, in order to facilitate the filtering of the emissions stream, the present invention may further comprise at least one CO2 filter 18 and at least one secondary pollutants filter 19. The at least one CO2 filter 18 serves to remove CO2 from the emissions stream. The at least one secondary pollutants filter 19 serves to remove other pollutants from the emissions stream including, but not limited to, sulfur dioxide (SO2), nitrogen dioxide (NO2), or carbon monoxide (CO). Further, the filtration housing 2 may further comprise a first chamber 3, an intermediate chamber 4, and a second chamber 5. The first chamber 3 preferably corresponds to the area where the emissions stream first enters the filtration housing 2. The intermediate chamber 4 corresponds to the area where the emissions stream flows into after passing the at least one CO2 filter 18. The second chamber 5 corresponds to the area where the emissions stream flows into after passing the at least one secondary pollutants filter 19. Accordingly, the first chamber 3 is positioned opposite to the second chamber 5 across the intermediate chamber 4. The first chamber 3 is in fluid communication with the intermediate chamber 4 by the at least one CO2 filter 18 so that the flow from the first chamber 3 to the intermediate chamber 4 is filtered by the at least one CO2 filter 18. The intermediate chamber 4 is in fluid communication with the second chamber 5 by the at least one secondary pollutants filter 19 so that the flow from the intermediate chamber 4 to the second chamber 5 is filtered by the at least one secondary pollutants filter 19. Further, the at least one polluted stream inlet 6 and the DAC mechanism 7 are in fluid communication with the first chamber 3 so that the polluted streams are directed towards the at least one CO2 filter 18. On the other hand, the at least one clean stream outlet 8 is in fluid communication with the second chamber 5 so that the emissions stream exits the filtration housing 2 only after the emissions stream flows through the at least one CO2 filter 18 and the at least one secondary pollutants filter 19. In other embodiments, additional chambers can be included in the filtration housing 2 to accommodate other filters to remove additional pollutants.

After the pollutants are removed from the emissions stream, the pollutants are separated from the emissions stream to be removed from the filtration housing 2. As can be seen in FIG. 1 through 4, the filtering mechanism 1 may further comprise at least one CO2 storage 10 and at least one secondary pollutants storage 11. The at least one CO2 storage 10 serves to collect the captured CO2 from the emissions stream until the captured CO2 is moved into the at least one pressure vessel 12. The at least one secondary pollutants storage 11 is used to collect other pollutants removed from the emissions stream until the pollutants can be transported for different purposes. Accordingly, the at least one CO2 storage 10 is positioned offset to the at least one polluted stream inlet 6 to separate the captured CO2 from the emissions stream. Similarly, the at least one secondary pollutants storage 11 is positioned offset to the at least one clean stream outlet 8 to separate the other pollutants from the clean stream. Further, the at least one CO2 filter 18 is in fluid communication with the at least one CO2 storage 10 so that the captured CO2 flows directly into the at least one CO2 storage 10. Similarly, the at least one secondary pollutants filter 19 is in fluid communication with the at least one secondary pollutants storage 11 so that the other captured pollutants flow directly into the at least one secondary pollutants storage 11. Furthermore, the at least one CO2 outlet 9 is in fluid communication with the at least one CO2 storage 10 so that the captured CO2 temporarily held in the at least one CO2 storage 10 can be moved to the at least one pressure vessel 12. In other embodiments, additional storage spaces can be included in the filtration housing 2 to retain other pollutants separate from each other or the clean stream.

In a preferred embodiment, the at least one CO2 filter 18 may be made from amine materials or other appropriate materials that remove CO2 from the emissions stream. Further, the at least one secondary pollutants filter 19 may be made from charcoal or other appropriate materials that remove other pollutants from the emissions stream. Furthermore, to facilitate the flow from the at least one CO2 storage 10 to the at least one pressure vessel 12, the at least one CO2 outlet 9 can be equipped with a ventilation mechanism that generates a flow from the at least one CO2 storage 10 to the at least one pressure vessel 12. The ventilation mechanism can include one or more plenum fans that can be controlled to remove the captured CO2 from the at least one CO2 storage 10. In other embodiments, other mechanisms can be utilized to control the outflow of the captured CO2 through the at least one CO2 outlet 9.

As can be seen in FIG. 1 through 4, to facilitate the dispersal of the inflow of CO2 throughout the greenhouse 15, the greenhouse 15 may further comprise a plurality of vertical vent pipes 17. The plurality of vertical vent pipes 17 includes several vent pipes oriented vertically to control the dispersion of the CO2 towards the plants growing in the greenhouse 15. To do so, the plurality of vertical vent pipes 17 is distributed throughout the greenhouse 15 to match the distribution of the plants growing inside the greenhouse 15. Further, the plurality of vertical vent pipes 17 is mounted within the greenhouse 15 to secure the plurality of vertical vent pipes 17 inside the greenhouse 15. In addition, each of the plurality of vertical vent pipes 17 is in fluid communication with the at least one CO2 inlet 16 so that the inflow of CO2 through the at least one CO2 inlet 16 is distributed towards each of the plurality of vertical vent pipes 17.

As can be seen in FIG. 1 through 4, to control the distribution of the CO2 inflow to each of the plurality of vertical vent pipes 17, the present invention may further comprise a controller 20, a power source 21, and a plurality of butterfly control valves 22. The controller 20 enables the direct or remote control of each of the plurality of butterfly control valves 22. The power source 21 provides the power necessary to enable the operation of the plurality of butterfly control valves 22. Accordingly, the plurality of butterfly control valves 22 is mounted within the at least one CO2 inlet 16 so that the CO2 inflow can flow through each of the plurality of butterfly control valves 22. Further, each of the plurality of vertical vent pipes 17 is in fluid communication with the at least one CO2 inlet 16 by a corresponding control valve of the plurality of butterfly control valves 22. This way, authorized users can control which control valves are opened or closed. Further, the plurality of butterfly control valves 22 is electronically connected to the controller 20 so that the desired control valves can be directly or remotely opened or closed. Furthermore, the plurality of butterfly control valves 22 is electrically connected to the power source 21 so that the plurality of butterfly control valves 22 can operate without direct force from the staff. In other embodiments, different mechanisms can be utilized to control the CO2 inflow through the at least one CO2 inlet 16.

In some embodiments of the present invention, the greenhouse 15 may further include a ventilation system to control the release of oxygen into the atmosphere. The ventilation system can be integrated into the greenhouse 15 in such a way that the ventilation system does not obstruct with the growth of the plants or the operation of other systems. For example, the ventilation system can be a retractable roof installed on the greenhouse 15 that can be selectively opened to enable the release of oxygen out of the greenhouse 15. The ventilation system may also include a set of fans that can be engaged to enable the outflow of oxygen from the greenhouse 15.

In other embodiments of the present invention, the greenhouse 15 may further include an irrigation system that is used to deliver water and other nutrients to the growing plants. The irrigation system can include several valves distributed throughout the greenhouse 15 to deliver water and other nutrients to the growing plants. Furthermore, the irrigation system can also be used to deliver the captured CO2 to the growing plants. For example, the present invention may further include a liquid gas mixer. The liquid gas mixer can be connected in between the at least one pressure vessel 12 and the irrigation system so that the captured CO2 can be mixed with water and other nutrients prior to the water and the other nutrients being delivered to the growing plants inside the greenhouse 15. For efficiency, a pipe system may direct the liquid CO2 to the greenhouse 15. The liquid CO2 may be delivered to the plants in the greenhouse 15 by a sprinkler system or into the soil directly. The delivery of the liquid CO2 may be dependent on the choice of plants in the greenhouse 15. In other embodiments, different delivery mechanisms can be used to deliver the captured CO2 to the growing plants inside the greenhouse 15.

Although the invention has been explained in relation to its preferred embodiment, it is to be understood that many other possible modifications and variations can be made without departing from the spirit and scope of the invention.

What is claimed is:

1. A system for capturing and redirecting carbon emissions to a greenhouse comprising:
a filtering mechanism;
at least one pressure vessel;
a greenhouse;
the filtering mechanism comprising a filtration housing, at least one polluted stream inlet, a direct air capture (DAC) mechanism, at least one clean stream outlet, and at least one carbon dioxide (CO2) outlet;
the at least one pressure vessel comprising at least one vessel inlet and at least one vessel outlet;
the greenhouse comprising at least one CO2 inlet;
the at least one polluted stream inlet, the DAC mechanism, the at least one clean stream outlet, and the at least one CO2 outlet being externally integrated into the filtration housing;
the at least one vessel inlet and the at least one vessel outlet being externally integrated into the at least one pressure vessel;
the at least one CO2 inlet being externally integrated into the greenhouse;
the at least one CO2 outlet being in fluid communication with the at least one vessel inlet; and
the at least one vessel outlet being in fluid communication with the at least one CO2 inlet.

2. The system for capturing and redirecting carbon emissions to a greenhouse as claimed in claim 1 comprising:
at least one CO2 filter;
at least one secondary pollutants filter;
the filtration housing comprising a first chamber, an intermediate chamber, and a second chamber;
the first chamber being positioned opposite to the second chamber across the intermediate chamber;
the first chamber being in fluid communication with the intermediate chamber by the at least one CO2 filter;
the intermediate chamber being in fluid communication with the second chamber by the at least one secondary pollutants filter;
the at least one polluted stream inlet and the DAC mechanism being in fluid communication with the first chamber; and
the at least one clean stream outlet being in fluid communication with the second chamber.

3. The system for capturing and redirecting carbon emissions to a greenhouse as claimed in claim 2 comprising:
the filtering mechanism further comprising at least one CO2 storage and at least one secondary pollutants storage;
the at least one CO2 storage being positioned offset to the at least one polluted stream inlet;
the at least one secondary pollutants storage being positioned offset to the at least one clean stream outlet;
the at least one CO2 filter being in fluid communication with the at least one CO2 storage;
the at least one secondary pollutants filter being in fluid communication with the at least one secondary pollutants storage; and
the at least one CO2 outlet being in fluid communication with the at least one CO2 storage.

4. The system for capturing and redirecting carbon emissions to a greenhouse as claimed in claim 2 comprising:
the at least one CO2 filter being made from amine materials.

5. The system for capturing and redirecting carbon emissions to a greenhouse as claimed in claim 2 comprising:
the at least one secondary pollutants filter being made from charcoal.

6. The system for capturing and redirecting carbon emissions to a greenhouse as claimed in claim 1 comprising:
the greenhouse further comprising a plurality of vertical vent pipes;
the plurality of vertical vent pipes being distributed throughout the greenhouse;
the plurality of vertical vent pipes being mounted within the greenhouse; and
each of the plurality of vertical vent pipes being in fluid communication with the at least one CO2 inlet.

7. The system for capturing and redirecting carbon emissions to a greenhouse as claimed in claim 6 comprising:
a controller;
a power source;
a plurality of butterfly control valves;
the plurality of butterfly control valves being mounted within the at least one CO2 inlet;
each of the plurality of vertical vent pipes being in fluid communication with the at least one CO2 inlet by a corresponding control valve of the plurality of butterfly control valves;
the plurality of butterfly control valves being electronically connected to the controller; and
the plurality of butterfly control valves being electrically connected to the power source.

8. A system for capturing and redirecting carbon emissions to a greenhouse comprising:
a filtering mechanism;
at least one pressure vessel;
a greenhouse;
at least one CO2 filter;
at least one secondary pollutants filter;
the filtering mechanism comprising a filtration housing, at least one polluted stream inlet, a direct air capture (DAC) mechanism, at least one clean stream outlet, and at least one carbon dioxide (CO2) outlet;
the at least one pressure vessel comprising at least one vessel inlet and at least one vessel outlet;
the greenhouse comprising at least one CO2 inlet;
the filtration housing comprising a first chamber, an intermediate chamber, and a second chamber;
the at least one polluted stream inlet, the DAC mechanism, the at least one clean stream outlet, and the at least one CO2 outlet being externally integrated into the filtration housing;
the at least one vessel inlet and the at least one vessel outlet being externally integrated into the at least one pressure vessel;
the at least one CO2 inlet being externally integrated into the greenhouse;
the at least one CO2 outlet being in fluid communication with the at least one vessel inlet;
the at least one vessel outlet being in fluid communication with the at least one CO2 inlet;
the first chamber being positioned opposite to the second chamber across the intermediate chamber;
the first chamber being in fluid communication with the intermediate chamber by the at least one CO2 filter;
the intermediate chamber being in fluid communication with the second chamber by the at least one secondary pollutants filter;
the at least one polluted stream inlet and the DAC mechanism being in fluid communication with the first chamber; and
the at least one clean stream outlet being in fluid communication with the second chamber.

9. The system for capturing and redirecting carbon emissions to a greenhouse as claimed in claim 8 comprising:
the filtering mechanism further comprising at least one CO2 storage and at least one secondary pollutants storage;
the at least one CO2 storage being positioned offset to the at least one polluted stream inlet;
the at least one secondary pollutants storage being positioned offset to the at least one clean stream outlet;
the at least one CO2 filter being in fluid communication with the at least one CO2 storage;
the at least one secondary pollutants filter being in fluid communication with the at least one secondary pollutants storage; and
the at least one CO2 outlet being in fluid communication with the at least one CO2 storage.

10. The system for capturing and redirecting carbon emissions to a greenhouse as claimed in claim 8 comprising:
the at least one CO2 filter being made from amine materials.

11. The system for capturing and redirecting carbon emissions to a greenhouse as claimed in claim 8 comprising:
the at least one secondary pollutants filter being made from charcoal.

12. The system for capturing and redirecting carbon emissions to a greenhouse as claimed in claim 8 comprising:
the greenhouse further comprising a plurality of vertical vent pipes;
the plurality of vertical vent pipes being distributed throughout the greenhouse;
the plurality of vertical vent pipes being mounted within the greenhouse; and
each of the plurality of vertical vent pipes being in fluid communication with the at least one CO2 inlet.

13. The system for capturing and redirecting carbon emissions to a greenhouse as claimed in claim 12 comprising:
a controller;
a power source;
a plurality of butterfly control valves;
the plurality of butterfly control valves being mounted within the at least one CO2 inlet;
each of the plurality of vertical vent pipes being in fluid communication with the at least one CO2 inlet by a corresponding control valve of the plurality of butterfly control valves;
the plurality of butterfly control valves being electronically connected to the controller; and
the plurality of butterfly control valves being electrically connected to the power source.

14. A system for capturing and redirecting carbon emissions to a greenhouse comprising:
a filtering mechanism;
at least one pressure vessel;
a greenhouse;
at least one CO2 filter;
at least one secondary pollutants filter;
the filtering mechanism comprising a filtration housing, at least one polluted stream inlet, a direct air capture (DAC) mechanism, at least one clean stream outlet, and at least one carbon dioxide (CO2) outlet;
the at least one pressure vessel comprising at least one vessel inlet and at least one vessel outlet;
the greenhouse comprising at least one CO2 inlet;
the filtration housing comprising a first chamber, an intermediate chamber, and a second chamber;
the at least one polluted stream inlet, the DAC mechanism, the at least one clean stream outlet, and the at least one CO2 outlet being externally integrated into the filtration housing;
the at least one vessel inlet and the at least one vessel outlet being externally integrated into the at least one pressure vessel;
the at least one CO2 inlet being externally integrated into the greenhouse;
the at least one CO2 outlet being in fluid communication with the at least one vessel inlet;
the at least one vessel outlet being in fluid communication with the at least one CO2 inlet;
the first chamber being positioned opposite to the second chamber across the intermediate chamber;
the first chamber being in fluid communication with the intermediate chamber by the at least one CO2 filter;
the intermediate chamber being in fluid communication with the second chamber by the at least one secondary pollutants filter;
the at least one polluted stream inlet and the DAC mechanism being in fluid communication with the first chamber; and
the at least one clean stream outlet being in fluid communication with the second chamber.

15. The system for capturing and redirecting carbon emissions to a greenhouse as claimed in claim 14 comprising:
the filtering mechanism further comprising at least one CO2 storage and at least one secondary pollutants storage;
the at least one CO2 storage being positioned offset to the at least one polluted stream inlet;
the at least one secondary pollutants storage being positioned offset to the at least one clean stream outlet;
the at least one CO2 filter being in fluid communication with the at least one CO2 storage;
the at least one secondary pollutants filter being in fluid communication with the at least one secondary pollutants storage; and
the at least one CO2 outlet being in fluid communication with the at least one CO2 storage.

16. The system for capturing and redirecting carbon emissions to a greenhouse as claimed in claim 14 comprising:
the at least one CO2 filter being made from amine materials.

17. The system for capturing and redirecting carbon emissions to a greenhouse as claimed in claim 14 comprising:
the at least one secondary pollutants filter being made from charcoal.

18. The system for capturing and redirecting carbon emissions to a greenhouse as claimed in claim 14 comprising:
a controller;
a power source;
a plurality of butterfly control valves;
the greenhouse further comprising a plurality of vertical vent pipes;
the plurality of vertical vent pipes being distributed throughout the greenhouse;
the plurality of vertical vent pipes being mounted within the greenhouse;
each of the plurality of vertical vent pipes being in fluid communication with the at least one CO2 inlet;
the plurality of butterfly control valves being mounted within the at least one CO2 inlet;
each of the plurality of vertical vent pipes being in fluid communication with the at least one CO2 inlet by a corresponding control valve of the plurality of butterfly control valves;
the plurality of butterfly control valves being electronically connected to the controller; and
the plurality of butterfly control valves being electrically connected to the power source.
